(19) United States
(12) Patent Application Publication
(10) Pub. No.: US 2009/0016504 A1
(43) Pub. Date: Jan. 15, 2009

(54) System and Method for Providing Communications to a Group of Recipients Across Multiple Communication Platform Types

(76) Inventors: Stephen Mantell, Chappaqua, NY (US); Stuart Rohrer, New York, NY (US); Thomas N. Heymann, Chappaqua, NY (US)

Correspondence Address: Jordan A. Sigale;Loeb & Loeb LLP, Ste. 2300, 321 North Clark St., Chicago, IL, 60610, US

(21) Appl. No.: 11/775,612

(22) Filed: Jul. 10, 2007

(51) Int. Cl. H04M 11/00

(52) U.S. Cl. 379/101.01

(57) ABSTRACT

A communications system for enabling communications between a prime user and members of a group. The system includes a first set of interlaces capable of communicating with the prime user via a first plurality of communication platforms using at least a first format and a second format; and a second set of interfaces capable of communicating with each of the members of the group via a second plurality of communication platforms using at least the first format and the second format. The system also includes a session manager coupled to the first set of interfaces having a plurality of routines configured to enable a prime user in communication with any one of the first set of interfaces to create a message to be transmitted to a selected group in either the first format or the second format; and a format converter capable of converting the message between the first and second formats. A communication controller is configured to obtain the message from the first database in both the first and second formats, obtain group member information regarding each member's contact preferences, and to initiate transmission of the message from the second set of interfaces to the selected group members using various, communication platforms based on the member's contact preferences.

### FIELD OF THE INVENTION

This invention relates generally to communication systems and, more particularly, to a system and method for providing communications to a group of recipients across multiple types of communication platform types.

### BACKGROUND OF THE INVENTION

There are many examples of groups that require rapid and effective communications between group members who may have different communication devices and may be in different locations. One example of such a group is a youth sports team. Members of a sports team, such as players, coaches, parents, and officials, often need to be rapidly advised of last-minute changes in schedules or logistics, as might often occur with adverse weather events at an outdoor playing field. The members of these types of groups, however, are often physically located in different places, use different types of communication devices such as landline phones, cell phones, web-enabled computers, web-enabled mobile devices, and others, and usually have a range of communication suppliers.

Generally, one common practice utilized by such groups to communicate with members has been to establish a “phone tree.” For example, in the case of a youth sports team, a group leader (such as a coach), places a telephone call to one or more group members (such as other coaches, parents, or players) to advise them of a change in scheduling or logistics. Each person who receives the message from the group leader is then responsible for placing phone calls to a subset of additional people who need to get the same message promptly. Depending on the size of the group, this second tier of recipients may in turn be responsible for passing the information to additional lists of people, and so on. In this manner, the message can be spread to a relatively large group through the shared effort of a relatively small group of communicators within a period of time far less than if the group leader had to contact each group member directly. However, this method of distribution is not substantially instantaneous and phone trees are difficult to update and are often incomplete.

Another common practice is the creation of an email distribution. In this instance, the group leader may compose an email message to be sent to a list of pre-assembled email addresses, enabling rapid delivery of information to group members who are on the list. Yet another common practice is the posting of information in a central location, such as a web page or as a recorded announcement on a published phone number, where group members can go to retrieve messages.

Although the above-described methods of communicating with a group can be effective in certain circumstances, their practice becomes less than effective for delivering timely information to a dispersed group of recipients and collecting verifications or feedback. A phone tree, for example, is only effective if the participants are reachable at the listed telephone number at the time the message needs to be delivered. An email list is only effective if its addressees all check their email inboxes on a timely basis. Similarly, the posting of information at a central location is only effective if the members consistently check that central location.

Furthermore, the effort required to collect and maintain lists of telephone numbers, email addresses, or other contact information can also be challenging. The coordination of people and responsibilities in a communication chain can also be cumbersome. It becomes even more cumbersome if the group leader needs to collect timely responses from all the group members, which adds considerable complexity and the possibility for breakdown in the communication process.

Accordingly, there is a need for a system and method that allows a group leader to rapidly compose and disseminate a message to group members, across a variety of communication platforms, and to efficiently collect feedback from those group members.

### SUMMARY OF THE INVENTION

The present invention provides a communications system for enabling communications between a prime user and members of a group across various communication platforms using multiple formats (such as text, voice, video, etc.). The invention includes a first set of interfaces, a second set of interfaces, a session manager, a first format converter, a first database, a second database, and a communication controller.

The first set of interfaces is configured to be capable of communicating with the prime user via a first plurality of communication platforms using, for example, at least a first format and a second format, and the second set of interfaces is configured to be capable of communicating with each of the members of the group via a second plurality of communication platforms using at least the first format and the second format. The session manager is coupled to the first set of interfaces and includes a plurality of routines configured to enable a prime user in communication with any one of the first set of interfaces to create a message to be transmitted to a selected group, where the session manager capable of receiving the message from the prime user in either the first format or the second format. The first format converter is capable of converting the message from the first format to the second format. The first database is coupled to the session manager and the format converter, and is capable of storing the message created by the prime user in both the first format and the second format. The second database is coupled to the session manager to store information about the members of the group. Such group member information may include contact information identifying one or more contact addresses for each of the group members and format information identifying a format in which each group member would prefer to receive messages.

The communication controller is configured to obtain the message from the first database in both the first and second formats, to obtain the group member information from the second database, and to initiate transmission of the message from the second set of interfaces to the selected group members using at least one of the second set of communication platforms based on the contact information and the format information for each selected group member. Thus, the message can be transmitted to some of the selected group members in a first format, and the message can be transmitted to others of the selected group members in a second format.

In one embodiment, the communication controller may also be configured to determine status information for each selected group member to whom the message was transmitted. Such status information may include information regarding at least one of whether the message was received by a particular group member, whether the message was confirmed by the particular group member, and whether feedback was received from the particular group member. In this embodiment, the communication controller may further be configured to determine whether to resend the message to each selected group member based on the status information for the respective group member.

Feedback responses may also be provided back to a prime user using any type of interface. Thus, in one embodiment, the communication controller may be configured to receive feedback responses to the transmitted message from the selected group members via the second set of interfaces, wherein the responses from one portion of the selected group members are received in a first format and responses from another portion of the selected group members are received in a second format. In this embodiment, the system may includes a second format converter capable of converting the feedback responses received in the first format to the second format and to convert the feedback responses received in the second format to the first format.

In yet another embodiment, the communication controller may also include an advertising manager for inserting at least one of an advertisement or sponsorship information into the message being transmitted to the selected group members.

In another aspect, the present invention may also include a method for enabling communications between a prime user and members of a group. The method includes providing a second set of interfaces capable of communicating with the prime user via a second plurality of communication platforms using at least a first format and a second format; providing a second set of interfaces capable of communicating with the members of the group via a second plurality of communication platforms using at least a first format and a second format; obtaining information regarding the members of the group, the group member information including contact information identifying one or more contact addresses for each of the plurality of group members, and format information identifying a format in which each group member would prefer to receive messages; receiving a message from a prime user in the first format via one of the first plurality of communication platforms; converting the message from the first format to the second format; and transmitting the message to selected ones of the group members using at least one of the second plurality of communication platforms based on the contact information and the format information provided for each group member; wherein the message is transmitted to a portion of the selected group members using the first format and the message is transmitted to another portion of the selected group members using the second format.

### BRIEF DESCRIPTION OF THE FIGURES

FIG. 1 shows one exemplary embodiment of a two-way communication between a prime user and a group utilizing a messaging system in accordance with the present invention.

FIG. 2 shows one exemplary embodiment of a messaging system in accordance with the present invention.

FIG. 3 shows one exemplary embodiment of a session manager in accordance with the present invention.

FIG. 4 shows one exemplary embodiment of an active message database in accordance with the present invention.

FIG. 5 shows one exemplary embodiment of a communication controller in accordance with the present invention.

FIG. 6 shows one exemplary embodiment of a method for setting up a group in the messaging system of FIG. 1.

FIGS. 7a-d together shows one exemplary embodiment of an email interface for setting up a group in the messaging system of FIG. 1.

FIG. 8 shows one exemplary embodiment of a method for interfacing with the messaging system of FIG. 1 to create a message and review the status of pending messages.

FIG. 9 shows one exemplary embodiment of an interactive phone interface for creating and reviewing messages in the messaging system of FIG. 1.

FIG. 10 shows one exemplary embodiment of a method for transmitting message to a group from the messaging system of FIG. 1.

FIG. 11 shows one exemplary embodiment of a method for receiving status information from a group member receiving a message via a voice call.

FIG. 12 shows one exemplary embodiment of a method for receiving status information from a group member receiving a message via an SMS text message.

FIG. 13 shows one exemplary embodiment of an outbound routing controller in accordance with the present invention.

FIG. 14 shows one exemplary embodiment of a message transmitted from a coach to a plurality of players on a sports team in accordance with the present invention.

FIG. 15 shows one exemplary embodiment of a message transmitted from a professor to a group of students in accordance with the present invention.

### DETAILED DESCRIPTION OF THE INVENTION

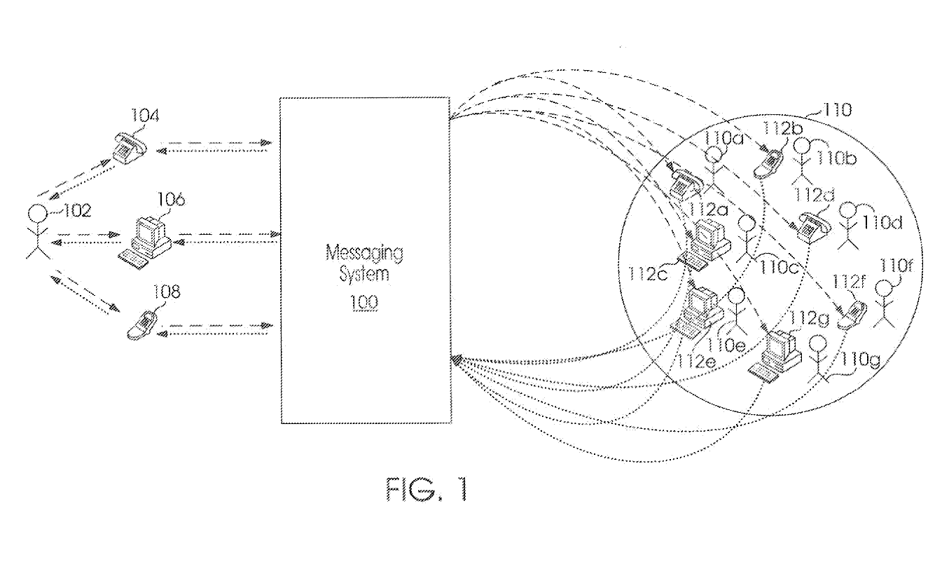

The present invention is a system and method that provides two-way communications between members of a group across multiple platforms based on the preferences established for the group members. In particular, as shown in FIG. 1, a messaging system 100 is provided to allow a group leader or other authorized individual (also referred to herein as a “prime user”) to establish and manage memberships for a group 110 using a variety of communication devices and communication formats. For instance, in the embodiment illustrated in FIG. 1, the prime user 102 may interface with the messaging system via a traditional landline phone 104 (for example, by means of voice communication), via a computer 106 (for example, by means of email, instant messaging or a web browser), or via a cellular phone 108 (for example, by means of voice communications or text messaging, and potentially by means of email, instant messaging and web browser if the cellular phone 108 is web-enabled). The manner of interface is a combination of user preference, convenience, and situation.

For each of the group members 110a-g, various preferences for the delivery of messages are also established, including the format in which each group member would like to receive his messages. As will be discussed in more detail below, such preferences may be established by the prime user 110a-11b, by the group members 110a-g, or any other authorized individual such as a network administrator. When a group communication is then required, the prime user 102 may compose a message using text, voice, or other format via any appropriate communication device 104-108. The prime user 102 may also request that either a receipt confirmation or feedback be provided by each group member 110a-g upon receiving the message.

After input, the prime user's message is processed, transformed into the appropriate formats, and routed by the messaging system 100 for delivery to each group member's preferred communication device using the group member's preferred format. For example, in the embodiment illustrated in FIG. 1, group members 110a and 110d (using landline phones 112a and 112d) and 110b (using cellular phone 112b) may prefer to receive the message as a voice message, group member 110g (using cellular phone 112g) may prefer to receive the message as a text message, group member 110c (using computer 112c) may prefer to receive the message as an email, group member 110e (using computer 112e) may prefer to receive the message as an instant message, and group member 110f (using computer 112f) may prefer the message to be posted to a website. Delivery status notifications, receipt-of-message confirmations, as well as any feedback, are then routed back through the system 100 and made accessible to the prime user 102 via any of the communication devices and formats discussed above.

Of course, it should be understood that while several communication devices and formats are discussed, the present invention is not limited to any specific set of devices or formats. For example, the present invention may also be configured to allow prime users and group members to interface with the messaging system using pagers, PDAs, teletypewriters (TTY), or the like. The present invention may also support the transmission of messages including photographs, video, audio files, computer code, and any other information transmissible digitally.

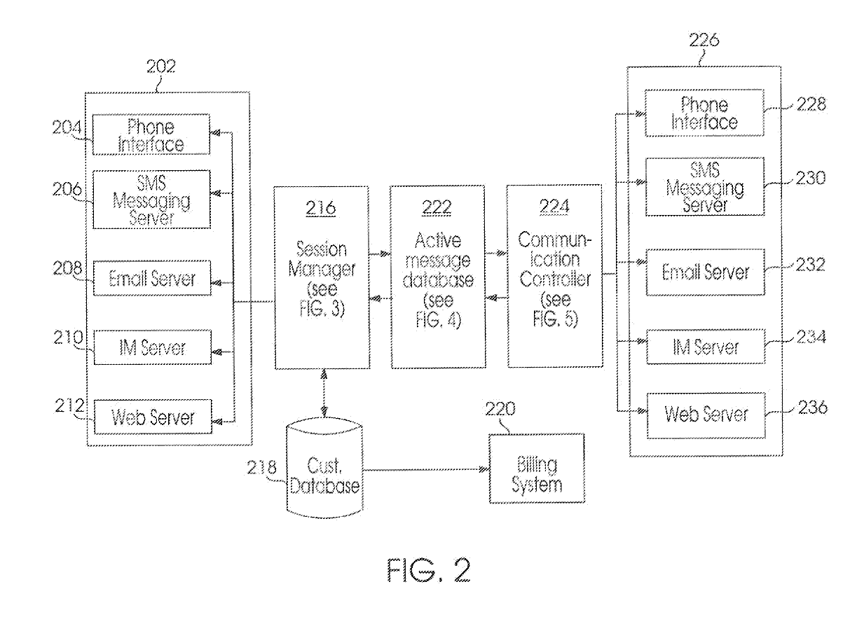

One exemplary embodiment of a messaging system 100 in accordance with the present invention is illustrated in FIG. 2. As shown, the system 100 includes a set of prime user interfaces 202 for communicating with one or more prime users 102 (see FIG. 1), and a set of group member interfaces 226 for communicating with group members 110 (see FIG. 1).

The prime user interfaces 202 are configured to permit a prime user 102 to communicate with the messaging system 100 using any one of a number of different devices and formats. For example, in the embodiment shown in FIG. 2, the prime user interfaces 202 may include a phone interface 204 that allows access to the messaging system via a voice call placed on a telephone device (such as a landline phone 104, a cellular phone 106, or the like). The prime user interfaces 202 may also include a SMS server 206 to permit access using an SMS text client (such as landline phone 104 or cellular phone 106 enabled for SMS texting), an email server 208 to permit access using an email client, an IM server 210 to permit access using an IM client, and a web server 210 to permit access using a web browser.

Similarly, the group member interfaces 226 are configured to be capable of communicating with group members using a variety of formats. For example, in the embodiment shown in FIG. 2, the group member interfaces 226 may include a phone interface 228 (such as an automatic phone dialer) for communicating with group member telephone devices, an SMS messaging server 230 for communicating with group member SMS text clients, an email server 232 for communicating with group member email clients, an IM server 234 for communicating with group member IM clients, and a web server 236 for communicating with a predetermined group web page. Of course, it is understood that while several interface examples have been provided, the present invention is not limited to these interfaces and may be utilized with any other type of communication technology.

As illustrated in FIG. 2, the messaging system 100 also includes a session manager 216, a customer account database 218, a billing system 220, an active message database 222, and a communication controller 224. The session manager 216 includes various group setup, message creation, and status review routines enabling a prime user 102 who has accessed the messaging system 100 via any one of the prime user interfaces 202 to create a group, edit group information, generate messages to be transmitted to the group, or review the status of a previously transmitted message. For example, as will be described in more detail below, the various group setup routines may include functionality that permits the prime user 102 to establish a new account, establish one or more groups, enroll group members, set default message priority levels, identify group member contact preferences, select preferences for receiving status updates, and select options for including advertising and/or sponsorship information in sent messages. The message creation routines may include functionality to permit the prime user 102 to select a previously created group, create a message for the selected group, alter message priority levels, set a requested feedback response, and/or alter any previously set options and preferences before sending the message. The status review routines may also include functionality to permit the prime user 102 to review the number of group members to whom a certain message had been successfully delivered, review the number of group members that have confirmed receipt of the message, and/or to review the feedback received from the various group members.

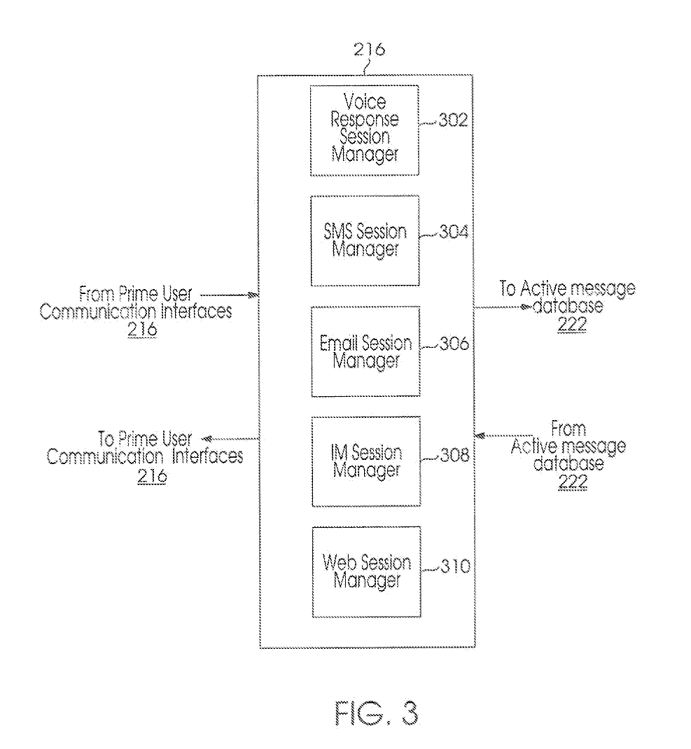

The various routines employed by the session manager 216 are also preferably optimized for each type of communication method that may utilized by the prime user to interact with the system 100. Thus, in one embodiment shown in FIG. 3, the session manager may include a separate voice session manager 302, SMS session manager 304, email session manager 306, IM session manager 308, and web session manager 308 to permit the prime user to efficiently perform group setup, message creation, and status review by voice call, text, email, IM, or web browser, respectively,

The customer database 218 is coupled to the session manager 216, and stores information input by the prime user 102 or any other authorized individual regarding each created group, the prime user, the group members, and any settings or preferences for the group. The customer database may also be configured to store information identifying the billing methods for a group as well as each group's utilization of the messaging system 100. Of course, while the customer database 218 is illustrated as a single database, it is understood that the customer database may be a distributed database. As such, information relating to various groups may be stored at various locations including, for example, on a prime user's and/or group member's home computer.

The billing system 220 utilizes the information stored in the customer database 218 to determine an amount to be billed to each group. For example, each group may be billed based on the number of messages transmitted, the types of devices to which each message was transmitted, or any other criteria.

The active message database 222 is configured to store information regarding active messages and any feedback received for each such messages. For purposes of this description, “active messages” may be defined as any message that has not yet been transmitted, reviewed, deleted, or any other criteria that may be established by a prime user to determine how long each message is to maintained as active.

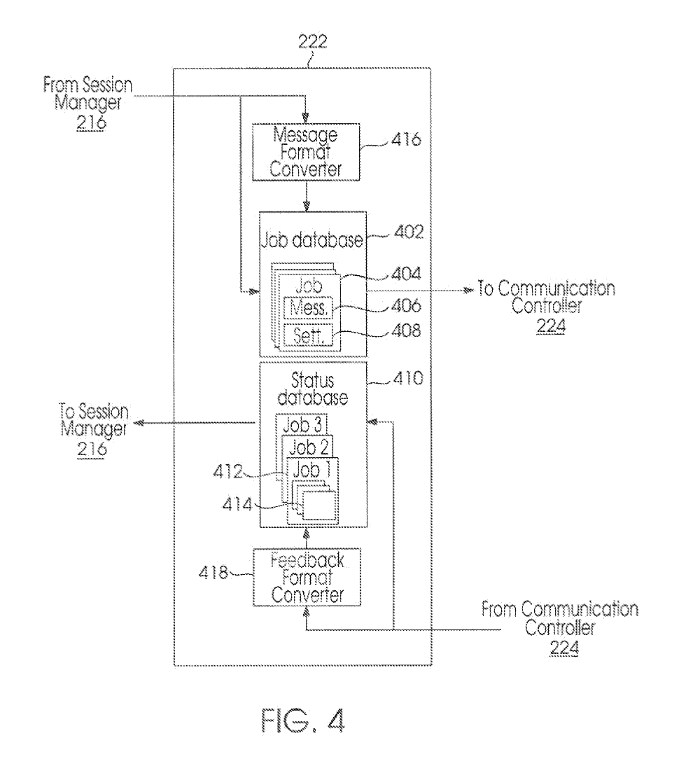

One exemplary embodiment of a active message database 222 is illustrated in FIG. 4. In this embodiment, the active message database 222 includes a job database 402 and a status database 410. The job database 402 receives each created message from the session manager 216, along with any defined settings and preferences for the message, such as group member contact preferences, a message priority level, and options for including advertising and sponsorship content. Upon receiving the created message and the associated settings and preferences, the job database creates a message job file 404 and stores the message 406 along with the settings and preferences 408 in the message job file 404. In this way, each individual message job file 404 is self-contained including all the necessary information required to complete a specific message transmission.

Status information is received by the active message database 222 from the communication controller 224, and stored in the status database 410. Such status information 414 may include, for each group member, an indication of whether the message has been successfully delivered, receipt-of-message confirmations from the group member, or feedback from the group member. Preferably, as shown in FIG. 4, the status database 410 organizes the status information 414 within status job files 412, each of which corresponds to a particular message job file 404 in the job database 402. In this way, status information for any individual message for each group member can be easily retrieved.

As shown in FIG. 4, a message format converter 416 may also be coupled between the session controller 216 and the job database 402 in order to translate created messages to a different format. For example, in one embodiment, the message format converter 416 may include both a text-to-speech converter and a speech-to-text converter for translating text based messages to voice, or vice versa. In this way, created messages can be translated and saved to the job database in each format required by group members that are to receive the message. Alternatively, the message format converter 416 may be positioned within the communication controller 224 or the group member communication interfaces 226, in which case messages may be translated at the time of transmission.

Similarly, a feedback format converter 418 may also be coupled between the communication controller 224 and the status database 410 in order to translate the format of received group member feedback. Thus, as with message format converter 406, feedback format converter 408 may include a text-to-speech converter and a speech-to-text converter for translating text based feedback from group members to voice, or vice versa. The feedback may thus be saved within the status database 410 in each format that may be utilized by a prime user 102 or other authorized individual to review the feedback information. As a result, the feedback can be quickly and easily reviewed using any type of device regardless of the format in which the feedback was received.

Of course, if the messaging system is configured to be interoperable with other formats, such as video, it should be understood that format converters 406 and 408 may also be provided with additional types of conversion algorithms in order to address such other formats.

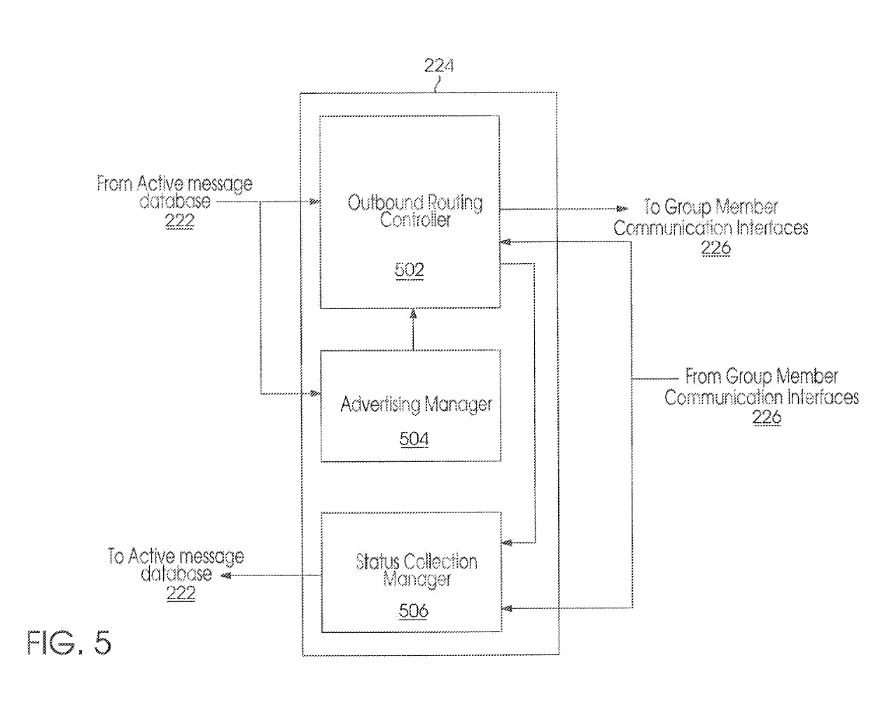

The communication controller 224 manages communications between the group member interfaces 226 and the various group member devices (e.g. 112a-g). In one embodiment shown in FIG. 5, the communication controller 224 may include an outbound routing controller 502, an advertising manager 504, and a status collection manager 506.

The outbound routing controller 502 receives message job files 404 from the job manager 402, prioritizes the message job files 404 based on their priority level, and initiates transmission of the corresponding message 406 from the group member interfaces 226 to each group member based on the settings and preferences 408 contained within the message job files 402. As will be discussed in more detail below, the outbound routing controller 502 may also be configured to review the status of each message, and if necessary, to resend the message to one or more group members using the same or different format.

The advertising manager 504 is coupled to the outbound routing controller 502, and is configured to insert preconfigured advertising information into each transmitted message. For example, in one embodiment, a short advertisement may be inserted at any time within a prime user created message, but preferably before the end of the message to ensure that group members read or listen (as appropriate) to the advertisement before the message concludes. The specific advertisement may also be selected based on the type of group that the message is being sent to. For example, if the group is a sports team, the advertisement may be for an athletic apparel company, a sports drink, or the like.

In another embodiment, advertisements may also be targeted based on each group member's individual information rather than simply on the type of group for which the message is being sent. For example, if a particular individual is a member of several different groups, an advertisement to be inserted in the message transmitted to that individual may be selected based on any or all of the groups in which the individual is a member. Advertisements may also be selected based on a group member's age and/or geographic location. The advertisement may also be in voice, text, picture, or video format, depending on the capabilities of the group member device that is to receive the message. Thus, it should be understood that each instance of the message sent to various group members may include a different advertisement.

In another embodiment, the advertising manager 504 may also be configured to insert sponsorship information into each message to identify a sponsor of the team. For instance, using again the example of a sports team, the sponsorship information may include the name of the league in which the sports team is playing, the name of the bar or restaurant sponsoring the team, or the like. Such advertising and sponsorship information may be used as one source of revenue for the messaging system 100 and/or as a method to offset costs associated with message transmissions.

In yet another embodiment, the advertising manager 504 may also be capable of aggregating group member information from across multiple groups. As a result, advertising and sponsorship information may be targeted to large sets of individuals, regardless of their group affiliation, based on age, interests, geographic location, or any other criteria.

The status collection manager 506 is configured to receive status information for each instance of the message sent to the group members 110, either directly from the group member interfaces 226 or via the outbound routing controller 502. As noted above, such status information may include, for each instance of the message sent to a group member, an indication of whether the message was received by the group member's device, an indication of whether the group member confirmed receipt of the message, and/or any feedback provided by the group member. Upon receiving status information for a particular group member, the status collection manager 506 passes the stains information to the active message database 222, where the status information is stored in the status database 410. In a scenario where multiple messages are being transmitted at the same time, the status collection manager 506 may also be configured to determine the particular message (or job) to which the received status information corresponds so that the status can then be stored in the appropriate status job file.

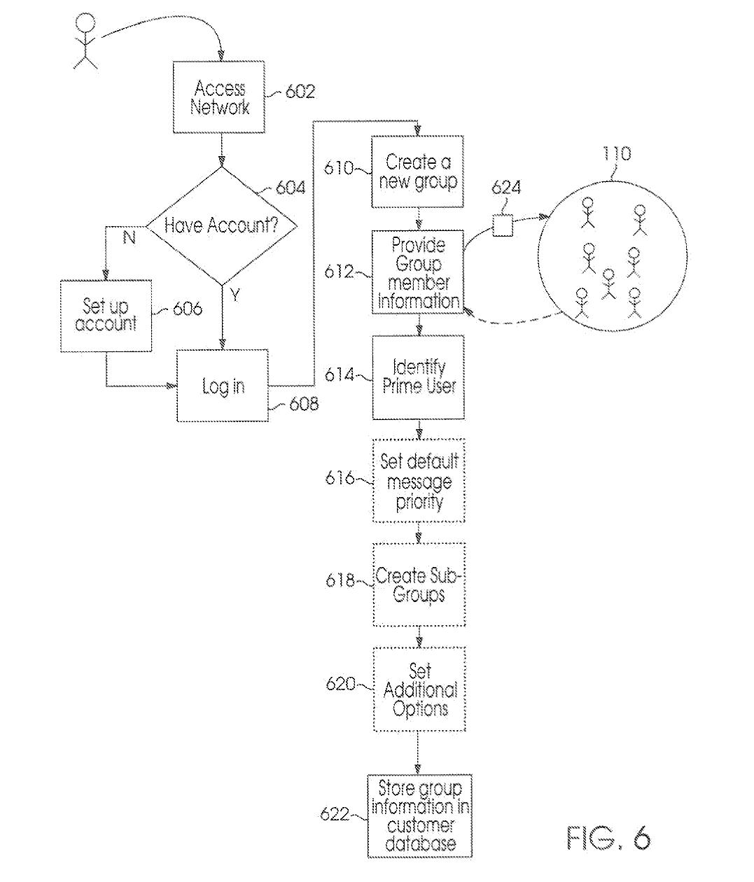

Turning now to FIG. 6, one exemplary embodiment of a method for establishing a new group within the messaging system 100 is described. In step 602, an individual accesses the messaging system using any one of the multiple communication formats described above, such as by a voice call, texting, email, IM, or web browser. In step 604, it is determined whether the individual has an account. If the individual does not have an account, the individual is prompted to set up a new account in step 606, in which case the individual either selects or is provided with an access code. Once an account is set up, or if the individual had already previously set up an account, the individual is prompted to log into the messaging system 100 using his access code in step 608.

In step 610, the individual is prompted to enter information for a new group. This may involve providing various information such as a name for the group, the type of group (for example, a sports team, classroom, school, etc.), the size of the group, billing information, and/or the time zone in which the group is located. To ease the process of entering such information, and to constrain the possible options for some of the information types (such, for example, the type of group), pull down menus may be provided to provide a predetermined set of options.

In step 612, the individual is prompted to provide the relevant group member information and contact preferences. This may include the names of each group member, the types of communication devices on which each group member can be contacted, the carrier or provider servicing each group member's communication devices, the communication formats which may be used to contact each group member, and the contact addresses (i.e. phone number, email, etc.) that should be used to attempt to contact the group member.

This may also include establishing each group member's preferences regarding the manner in which that group member is to be contacted. For example, multiple contact addresses may be organized in a hierarchal manner to indicate the order in which the contact addresses should be attempted. The information may also be used to indicate that different contact addresses and/or different orders, are to be used at different times of the day, or on different days. For certain group members an additional contact address may be specified in order to copy any messages transmitted to the group member to another party. For example, it may be desirable to copy messages sent to minors to their parents or guardians.

In one embodiment, this information may be input in step 612 directly by the individual that is establishing the group. In another embodiment, this information may also be input by a different individual that may be authorized to access the messaging system at a later time.

However, inputting such information for large groups can quickly become overly cumbersome for a single individual. Accordingly, in yet another embodiment, the individual may simply enter a single contact address for each group member. The contact address may be a phone number, an email, or any other contact address. As shown in FIG. 6, an invitation 624 may then be sent to each group member providing the group member with a preset access code, requesting that the group member log into the messaging system using the provided access code to establish their own contact preferences. The invitation 624 may be sent in any format such as a voice, SMS text, email, IM, or posted on a web page. The invitation may also be repeatedly transmitted to each group member until they input their information.

The access code may also be used by group members to update their own information and contact addresses at future times. It may also be used by group members to access the system in order to select other options, such as a Do-Not-Disturb option for ceasing messages for a period of time (for example, if the group member is on vacation), or the creation of sub-groups, as will be discussed in more detail below.

In yet another embodiment, the individual may be provided with the option of simply faxing the group member information to an administrator of the system, in which case the administrator would then enter the information for the group member. This service may be provided in order to entice individuals that are less technologically savvy to use the messaging system. This service may also be provided free of charge, for a preset fee, or in exchange for an individual agreeing to accept the inserting of advertising into transmitted messages.

In step 614, the individual may be prompted to identify the prime users that are given permission to create and send messages to the group members. This may involve providing the name for each prime user registered in system 100, an access code for each prime user, and/or contact information for the prime user (such as the contact addresses and formats that may he utilized by the prime user).

It is of course understood that the individual establishing the group may or may not designate themselves as a prime user. It should also be understood that each group may also include any number of designated prime users. For instance, in certain types of groups, it may be preferable to only have a single prime user. Examples of such groups may include a coach and his/her team; a principal and his/her school; a dean and a college; an executive and a business division; and a lay leader and a church group. However, in other instances, it may be preferable to designate multiple individuals as prime users. This may be the ease, for example, if a sports team includes multiple coaches, if a business division includes multiple executives or supervisors, etc. In yet other instances. It may also be desirable to allow any person in the group to transmit a message. In such cases, each group member may essentially be designated as a prime user.

In step 616, the individual may also be prompted to set the default priority level for messages transmitted to the group. In one exemplary embodiment, the messaging system may provide a choice of four available priority levels. In this embodiment, the first priority level may be a “date/time” priority level, which allows a prime user to specify the specific date and/or time at which to begin transmission of the message. Messages sent using this priority are preferably transmitted only to the primary contact address of each group member. The second priority level may be a “daily” priority level in which messages for the group are transmitted at the end of the day in which they were created. As with the first level, messages sent using the second priority level are also preferably transmitted only to the primary contact address of each group member.

The third priority level may be an “immediate” priority level in which messages are sent immediately upon their creation. In this level, messages are preferably first transmitted to the primary contact address of each group member. However, if the message is determined to have not been received by the intended group member's device, the messaging system may repeat the message every X minutes (either on the primary contact address or on other secondary contact addresses for the group member) until the message is determined to have been received. Similarly, if a message requires that each group member confirm receipt of the message, the messaging system may repeat the message every X minutes (either on the primary contact address or on other secondary contact, addresses for the group member) until the group member has confirmed receipt of the message. Of course, a limit may also be sent on the number of times that a message is sent to any individual group member.

The fourth priority level may be an “urgent” level that can be utilized for situations in which group members must be reached as soon as possible, such as a medical emergency. In this level, message are sent to every contact address for each group member simultaneously. As with the third level, the message may also be re-sent every X minutes to every contact address until it has been received and/or confirmed. Of course, it is understood that different levels may also be used and the messaging system may provide the option of having more or less than four priority levels.

In step 618, the individual may also be prompted to set-up any subgroups within the group. By creating sub-groups, a prime user may easily create messages that are to be sent only to a portion of the group rather than the whole. For instance, in the example of a sports team, sub-groups may be created for the players, the coaches, players' parents, referees, etc. A prime user can then create messages that are to be sent to the entire group, only to one of the sub-groups, or to any set of the sub-groups. A prime user may also designate additional prime users for each sub-group. For example, a coach may create a first sub-group authorizing transmission of messages from an offensive team captain to offensive players and a second sub-group authorizing transmission of messages from a defensive team captain to defensive players.

Additionally, although not illustrated in FIG. 6, group members may also be provided with the ability to create sub-groups within a group of which they are a member. For example, a principal may set up a group for his/her school. Various students may then choose to set up their own sub-groups within the group, for example, for communications among and between various school organizations and clubs. In these cases, the group members establishing the sub-group may appoint their own set of prime users that are given permission to transmit messages to members of the sub-group.

Of course, in order to ensure that the messaging system is not used for improper purposes (i.e. other than school related activities), the original prime users for the entire group, or other authorized individuals, may also be given the capability to cancel any sub-group created by group members and/or remove any individual's authorization as a prime user. The original prime user for the entire group may also require that any messages transmitted within such group member created sub-groups be copied to the prime user. In this way, the prime user for the entire group can monitor communications within any sub-groups.

In step 620, the individual may also be prompted to set any additional options for the group. Such additional options may include, for example, identifying any sponsorship information to be included with transmitted messages, and/or opting-in or opting-out of including advertisements in every message. This may also include selecting default options for providing status information to a prime user that sent a message. For example, one option may be to have status information transmitted to a selected prime user device every X minutes. Another option may be to simply require the prime user to access the system in order to obtain status information.

Additionally, the individual may also be offered the option to include or combine previously existing groups within a new “super” group. For example, let us assume that multiple schools in a school district have each set up individual groups for communicating with faculty, students, and students' parents for the respective schools. A superintendent of the school district may then create a new “super” group that includes each of the previously established groups for the various schools. In this example, the superintendent may he the prime user for the newly created “super” group, while the prime users for each of thee original groups remain intact as previously established.

The individual may also be provided with the option to save message information (including transmitted messages and/or status information for each transmitted message) indefinitely. If the individual does choose to save the messages information, the individual may also elect whether to save such message information in the format it was created, or in any other specific format. For example, the individual may elect to save all message information as voice, or to alternatively save all message information as text. The choice of the format in which to save the message information may be based on a personal choice and/or any fees assessed for maintaining the message information. For example, storing message information in voice format may require more storage space, and may therefore be more costly, than storing message information in text format. Such stored message may then easily be retransmitted by a prime user at any time by simply selecting the message. Of course, it is understood that if it a message originally recorded as voice is saved only as text, then any retransmission of the message would no longer utilize the original primer user's voice when sent as a voice call to group member phones. The storage of messages may also be useful in verifying transmission of messages for billing purposes.

Options other than those discussed above may also be provided based on the needs of any specific type of group.

In step 622, the information input during steps 610 through 618 is saved in the customer database for use in transmitting subsequently created messages for the group. Of course, it should be understood that the individual may be prompted for any of the information discussed above in any order. Assigned prime users or other authorized individuals may also be permitted to edit any of the above information at a later date by accessing and logging into the network. Such edits to the above information may also be performed using a different communication format or device than originally used when creating the group.

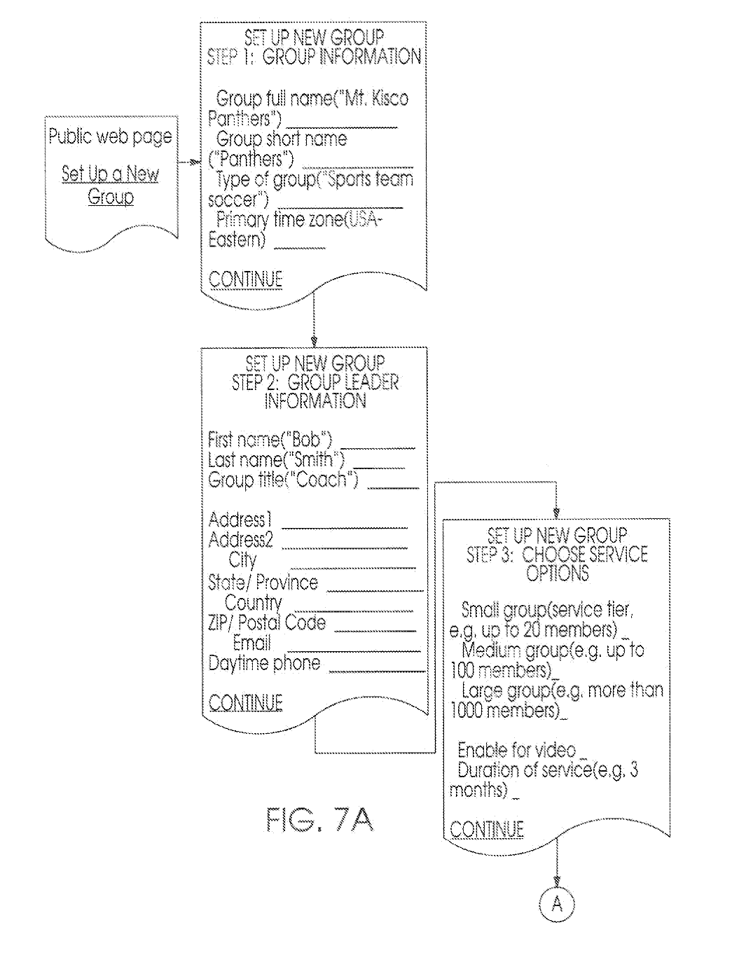

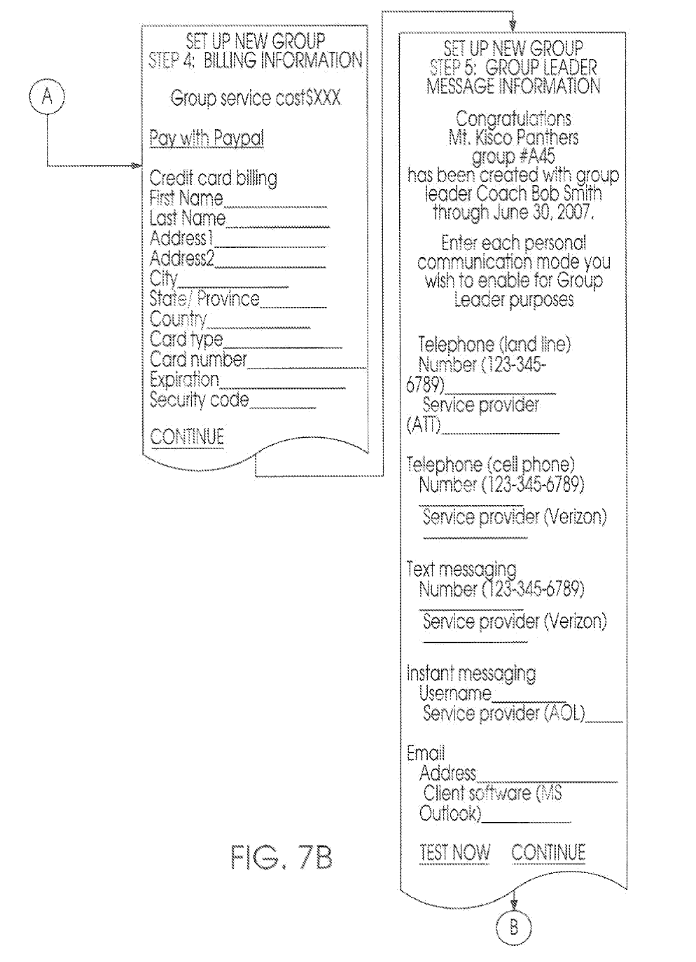

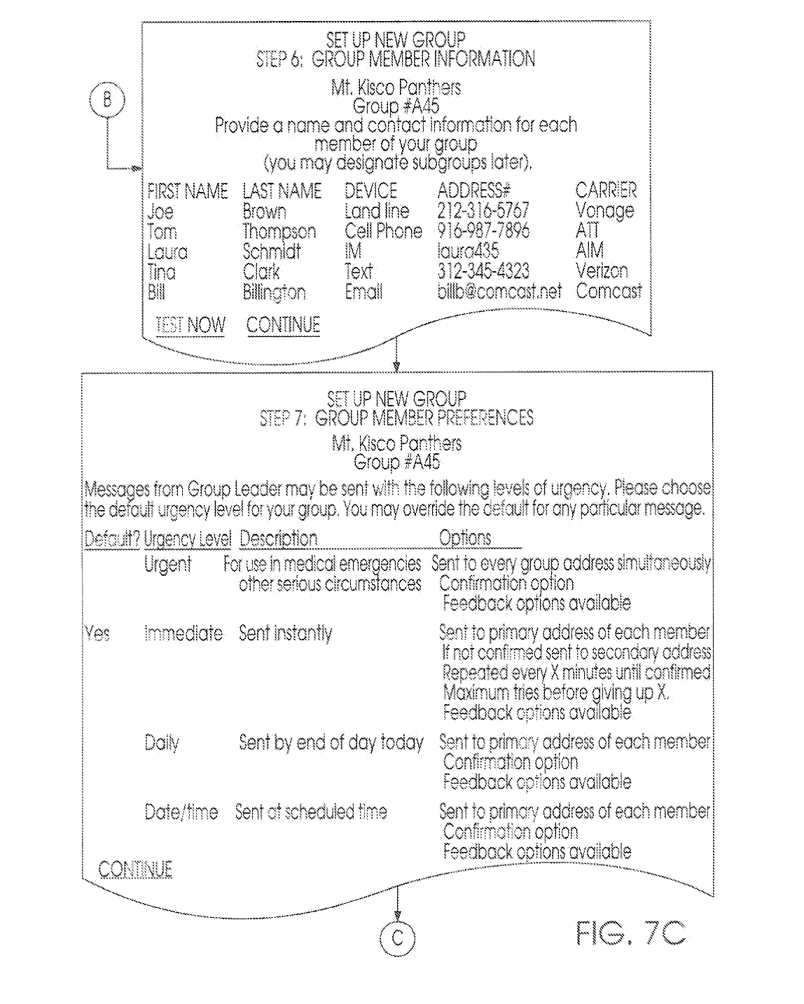

For illustration purposes only, one exemplary embodiment of a web-based interface for performing the steps described in FIG. 6 is illustrated in FIGS. 7a-d. However, one skilled in the art would readily understand that the steps discussed in FIG. 6 may also be utilized in connection with an interactive voice-based phone interface, a SMS text-based interface, an email-based interface, an IM-based interface, or any other format.

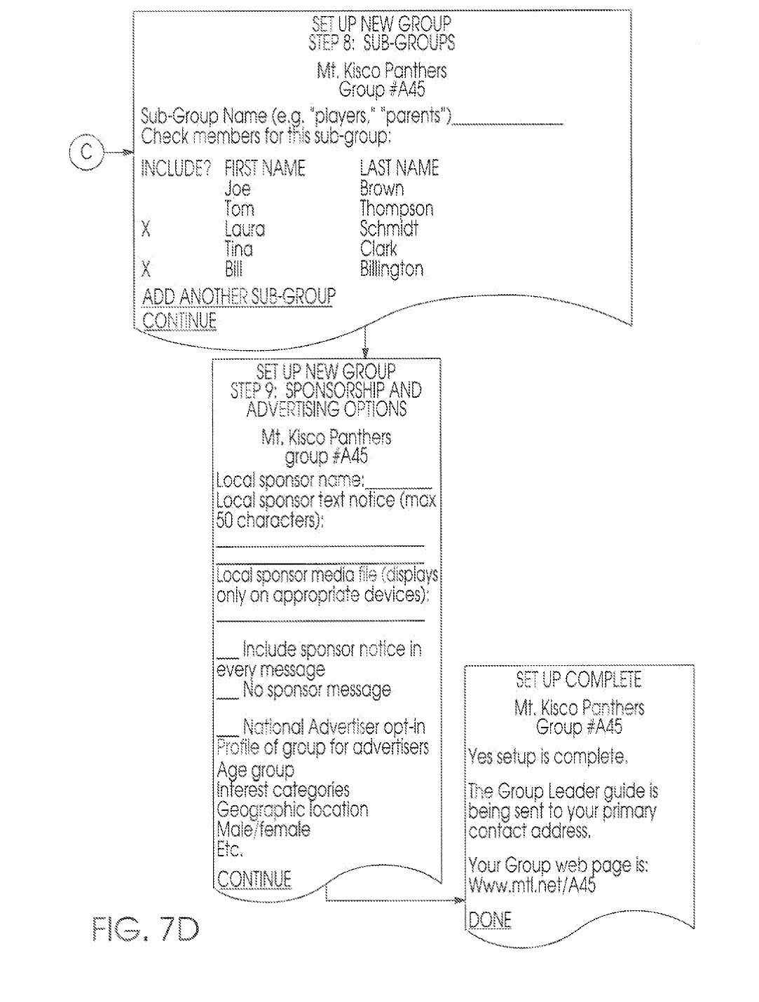

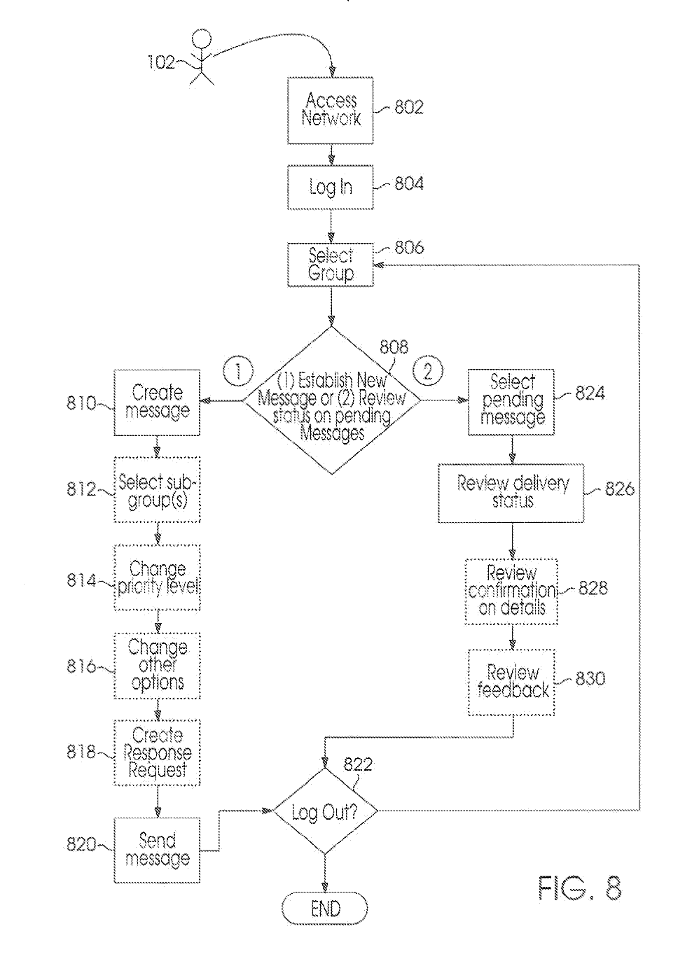

FIG. 8 illustrates one exemplary embodiment of a process for permitting a prime users to create new messages and reviewing pending messages. In step 802, a prime user accesses the network using any one of the multiple communication formats described above, such as by a voice call, texting, email, IM, or web browser. The prime user then logs into the network using a predetermined access code in step 804.

In step 806, the prime user may be prompted to select a previously established group within which the prime user would like to send a message. Of course, it is understood that this step would typically be necessary only if the prime user is associated with multiple groups. In yet another embodiment, the prime user may also be provided with a different access code for each group with which he/she is associated, in which case the group would be selected automatically based on the access code input in step 804.

In step 808, the prime user is prompted to select whether they would like to establish a new message or to review the status of a pending message. If they prime user elects to establish anew message, the process proceeds to step 810.

In step 810, the prime user is prompted to create a new message. For example, if the prime user accessed the messaging system using a voice call, the prime user may be prompted to record a voice message. If the prime user accessed the messaging system using an SMS text client, IM, email, or a web browser, the prime user may alternatively be prompted to provide a message in text format.

In steps 812 to 816, the prime user may then be given the option of selecting or altering various options or preferences. Thus, in step 812, the prime user may be given the option to limit the message to only one or more preset sub-groups. In step 814, the prime user may be given the option to select or change the priority level for the message. As discussed above, such priority levels may include a “data/time” level, a “daily” level, an “immediate” level, and an “urgent” level.

In step 816, the prime user may also be given the option to select or change other options such as how status information will be provided to the prime user, options for including advertisements or sponsorship information in the message, how any received status information should be stored, or any other option discussed above for FIG. 6. The user may also be provided with the option to retransmit the message at one or more later points. For example, if the original message is meant to remind a team of the start of the season over a month away, reminder messages may be sent every week until the day of the game. Some of these options may be also be fixed depending upon the nature of the user's account. For instance, accounts with lower subscription rates may be provided without the option to disable advertising in messages.

In step 818, the prime user may also be given the option to request that group members provide a response to the message. In one embodiment, the prime user may request that group members confirm receipt of the message. For example, messages transmitted using an automated voice message via phone interface 220 may include interactive prompts that request group members to confirm receipt by pressing a phone button or speaking a phrase into the phone. Message transmitted using text via the SMS messaging server 230, the emails server 232, or the IM server 234 may require that group members confirm receipt by responding to the message with a preset phrase or code or clicking on a hyperlink if the message was transmitted to a web-enabled device. If the message is posted on a web site via the web server 236, it may require group members to confirm that they have received the message by clicking a checkbox or providing some other type of indication on the web site. Of course, group members also need not be required to use the same format in which the message was sent. Thus, received messages may include an phone number, email address, or other contact information to which the group member may send his confirmation message. It may also be possible for the prime user to indicate to the system 100 that a response was received from outside the system, for example, if the primer user was informed by a group member directly, in order to stop sending any additional messages to that group member.

In another embodiment, the prime user may also request that group members provide feedback to the message. In this instance, the prime user may then further be prompted to identify the type of feedback that is desired. For example, the prime user may be given the option to create a YES/NO feedback request requiring a YES or NO answer, a multiple choice feedback request requiring group members to select one of multiple choices, or a freeform feedback request to which group members can provide any sort of answer. Once the prime user has selected the desired type of feedback request, the prime user may be prompted to create (using voice or text depending on the format being used to access the messaging system) the feedback question,

Messages sent with requests for freeform feedback may also include an option for a group member to have the message transmitted to another one of the user's contact addresses. This may he useful, for example, in the case that a group member receives a request for freeform feedback via text message, but would prefer to leave the feedback via voice, email, or the web.

In the step 820, the prime user may then select to transmit the created message using the selected setting and options. The prime user may then log out in step 820, or return to step 808, where the prime user can select another group for which the prime user wishes to create a new message or review pending messages.

If, in step 808, the prime user elects to review the status of a pending message, the process proceeds to step 822. In step 822, the prime user selects a pending message to review. In step 824, the user is provided with status information regarding delivery of the message to the various group members. In one embodiment, this information may simply provide a numerical count indicating the number of group members that have received the message versus those that have not received the message. In another embodiment, this information may also provide the names of each group member that has received the message and/or the names of the group members who have not received the message.

If the prime user has requested that group members confirm receipt of the message, the prime user may also elect to review the confirmation details in step 826. As with the delivery details, the confirmation details may simply provide a numerical count of group members who have confirmed versus those who have not, or alternatively, identify group members who have confirmed or not confirmed by name.

Similarly, if the prime user requested that group members provide feedback to the message, the prime user may also elect to review the feedback in step 828. In the case of a YES/NO feedback request or a multiple choice feedback request, the feedback may be aggregated to indicate the number of group members that elected each available response. In the case of a freeform feedback request, the prime user may then be allowed to review each individual received feedback response. As noted above, since the messaging system is capable of translating feedback between voice and text, the feedback may be provided to the prime user in any format and using any type of communication device regardless of the format in which the feedback was received. The prime user may then log out in step 820, or return to step 808, where the prime user can select another group for which to create new message or review pending messages.

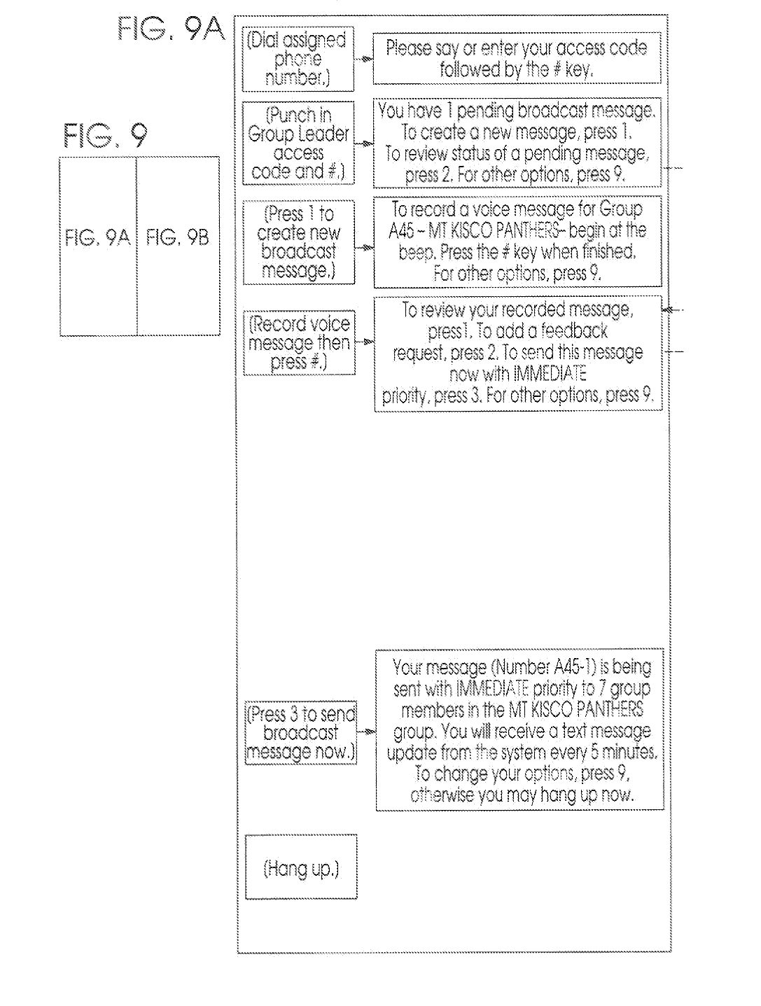

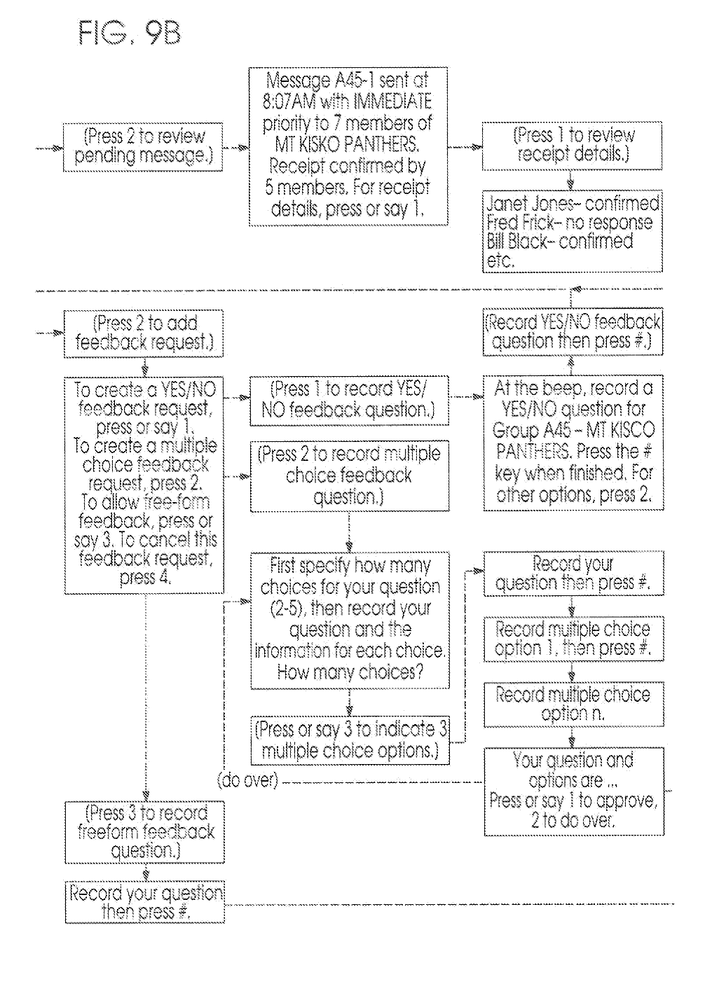

For illustration purposes only, one exemplary embodiment of an interactive voice interface for performing the steps described in FIG. 8 is illustrated in FIG. 9. However, one skilled in the art would readily understand that the steps discussed in FIG. 8 may also be utilized in connection with a SMS text-based interface, an email-based interface, an IM-based interface, a web-based interface or any other communication format type.

FIG. 10 illustrates one exemplary embodiment for transmitting a message to a group in accordance with the present invention. In step 1002, the session manager 216 detects that a message transmission has been requested, for example, by the prime user requesting that a created message be sent in step 818 above. In step 1004, the message is converted to the appropriate formats by the active message database 222. For example, a voice message may be converted to text if and only if any of the group members are to receive the message in text format. Similarly, a text message may be converted to voice if and only if any of the group members are to receive the message in voice format. In this manner, system overhead can be minimized.

In step 1006, the communication controller 224, and more particularly, the outbound routing controller 502, transmits an instance of the message to each group member via the group member interfaces 226 based on the priority level, group member contact preferences, and other previously selected settings and options.

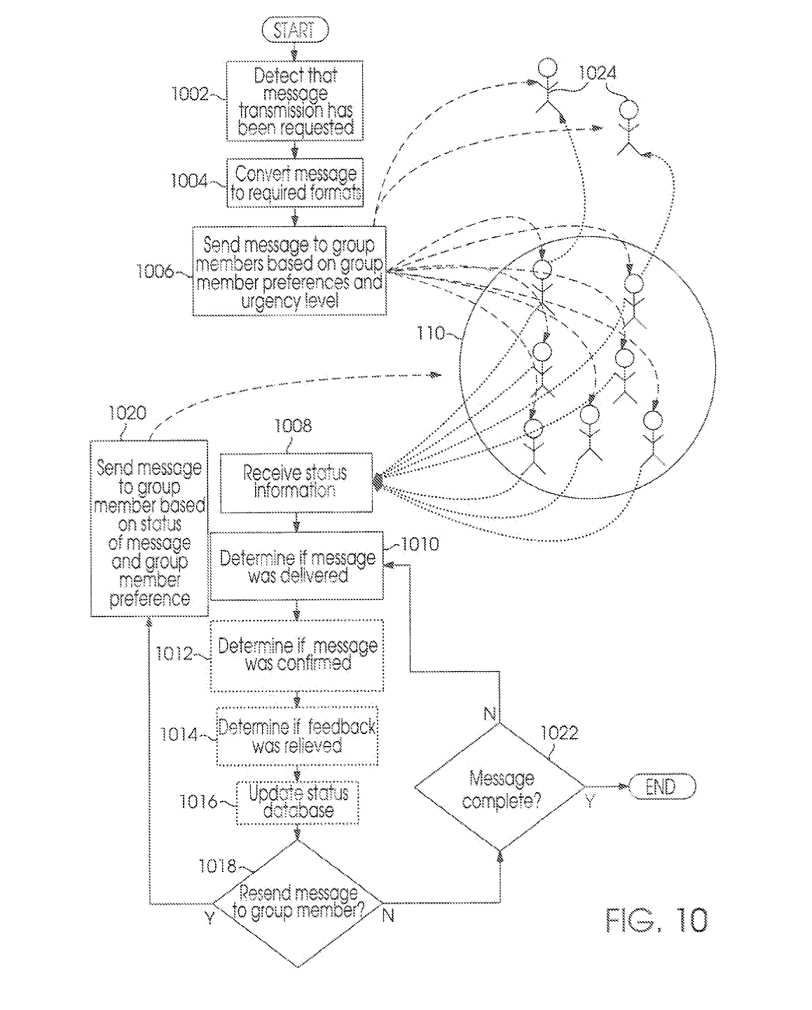

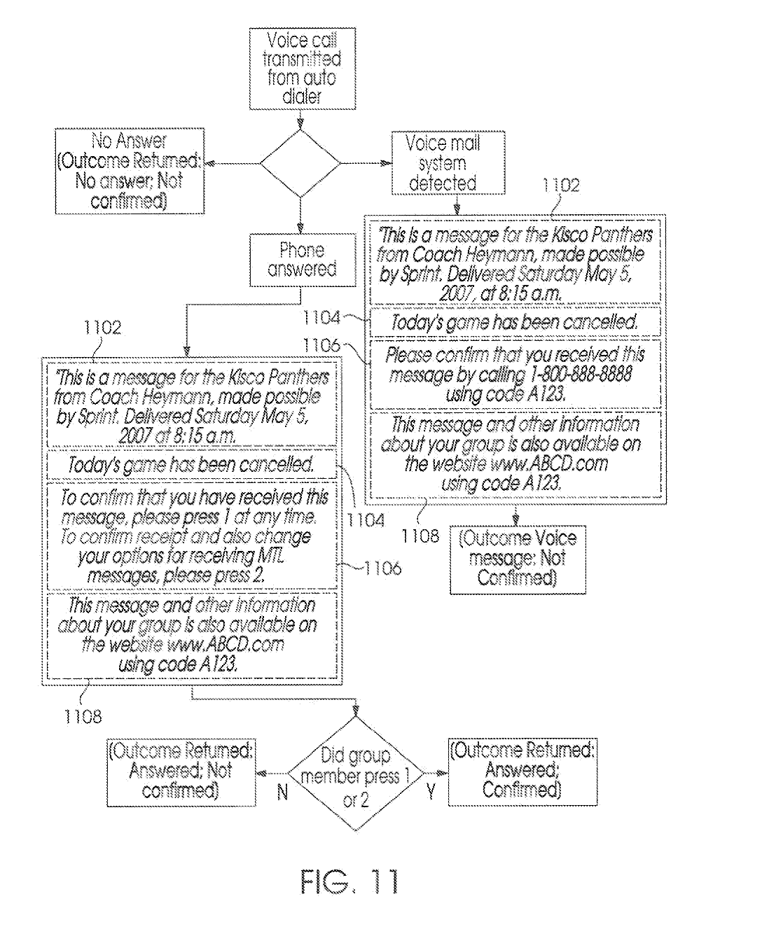

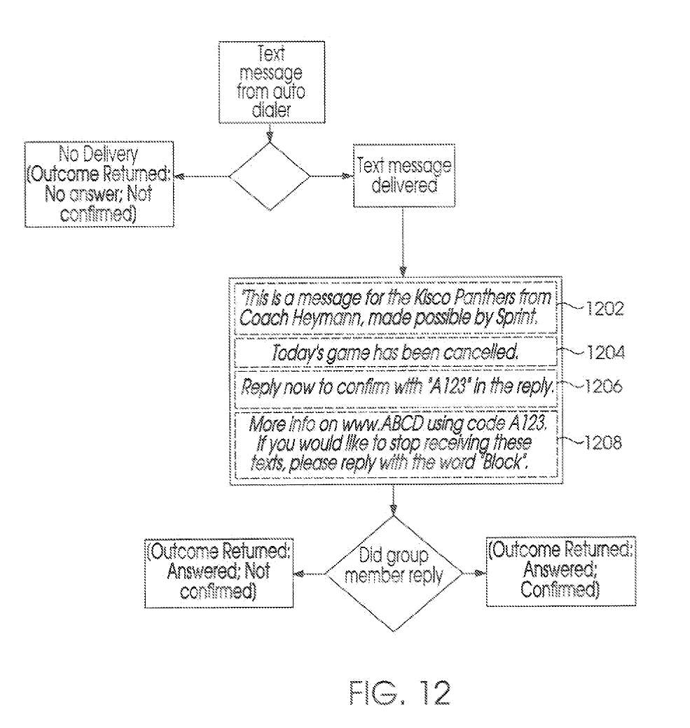

As noted above, the message may include a communication created by the prime user, advertising or sponsorship content, a request that receipt of the message be confirmed and/or a request for feedback. The message may also provide additional information such as website address for the group, an option to block any further messages to be sent to the same contact address (to permit individuals receiving the message in error to block further messages from being transmitted to them), and/or instructions on how to edit the recipient's group member information (see, for example, FIGS. 11 and 12).

As shown in FIG. 10, the message may also be copied to a secondary set of individuals 1024, which may be either inside or outside the group. For example, as noted above, messages transmitted to minors (for example, group, members 110a and 110b in FIG. 10) may be copied to their parents or guardians.

Status information relating to each transmitted instance of the message is then received in step 1008, whereby it is then reviewed by the outbound routing controller 502 in steps 1010-1020. As shown in FIG. 10, the status information may also be copied to the secondary set of individuals 1024 to monitor whether the intended recipient of the message has received, confirmed, and/or provided feedback.

In step 1010, for each transmitted instance of the message, the outbound routing controller 502 determines whether the message was received by the group member's communication device. As would be understood by one skilled in the art, various methodologies may be employed for determining whether a message was received. For example, if the message was sent as a voice message to a group member's phone, the message may be considered received if the group member answered his phone and the message may be considered not received if the group member did not answer his phone. The communication controller may also be capable of determining whether the message was sent to a voicemail system.

In another example, if the message was sent by text to a group member's phone, the message may be considered received if the text message was successfully delivered to the group member's phone. If the message was sent as an IM message, the message will be considered received if the group member was online at the time of transmission. If the message was sent as an email, the message may be considered received if the message was successfully delivered to the group member's email client, or alternatively, upon receiving an indication from the group member's email client that the message was opened by the group member.

If applicable, the outbound routing controller 502 also determines, for each transmitted instance of the message, whether the message was confirmed by the group member in step 1012. Numerous methods that may be utilized by a group member to confirm a message were discussed above. For instance, messages transmitted as an automated voice message via phone interface 220 may be confirmed by pressing a phone button or speaking a phrase into the phone (see, for example, the illustration of FIG. 11), while message transmitted using text via SMS messaging server 230 may require that group members confirm receipt by responding to the message with a preset phrase or code (see, for example, the illustration of FIG. 12). In the examples of FIGS. 11 and 12, it can be seen that the transmitted messages include a dynamically created announcement and advertising section (1102 in FIG. 11, and 1202 in FIG. 12), the message recorded or input by the prime user (1104 in FIG. 11, and 1204 in FIG. 12), a request for confirmation (1106 in FIG. 11, and 1206 in FIG. 12), and an identification of the group website (1108 in FIG. 11, and 1208 in FIG. 12).

If feedback was requested, the outbound routing controller 502 may also determine, for each transmitted instance of the message, whether feedback was received in step 1014. In step 1016 the status information for the message (which may include information regarding whether the each instance of the message was delivered, whether each instance of the message was confirmed, or whether feedback was received) is then passed to the active data manager 222 and updated in the status database 410. This updated status information may then be reviewed by the prime user or any other authorized individual by accessing the network as described in FIG. 6. Alternatively, the status information may also be automatically transmitted to the prime user or other authorized individual at a set time, on preset intervals, or upon the occurrence of a certain event.

In step 1018, the outbound routing controller 502 also determines whether the message should be resent to a particular group member based on the obtained status information for that group member. If the outbound routing controller 502 determines that a message should be resent, then the message is resent to the group member in step 1020 based on the status information and the group member's preferences. If the outbound routing controller 502 determines that a message should not be resent, then the process proceeds to step 1022, where the outbound routing controller 502 determines whether the message transmission has been completed (i.e. whether each group member has received the message, whether each group member has confirmed and/or provided feedback to the message, or based on any other preset criteria).

For example, let us assume that a transmitted message did not require any confirmation or feedback from group members. In this instance, the outbound routing controller 502 may be configured to resend the message to the group member only if it is determined that the message was not received by a group member's device. For a message requiring a confirmation, the outbound routing controller 502 may be configured to immediately resend the message to a group member if it is determined the message is neither received nor confirmed, resend the message only after a predetermined amount of time has elapsed if the message has been received but not confirmed, and to not resend the message if the message has been received and confirmed. Similarly, if feedback had been requested for a particular message, the outbound routing controller 502 may also be configured to periodically resend the message until feedback has been received.

Of course, the above scenarios are merely provided as examples and any type of algorithm may be used to determine when a message should be resent to a group member.

In each example above, resent messages are also preferably transmitted based on the group member's previously set preferences. Thus, a resent message may be transmitted using the same format and contact address, or using a different format and/or contact address. The system may also be configured to check a group member's profile if a message is either not received or responded to after a certain number of attempts to determine whether the group member has changed his contact preferences since the time that the message was initiated.

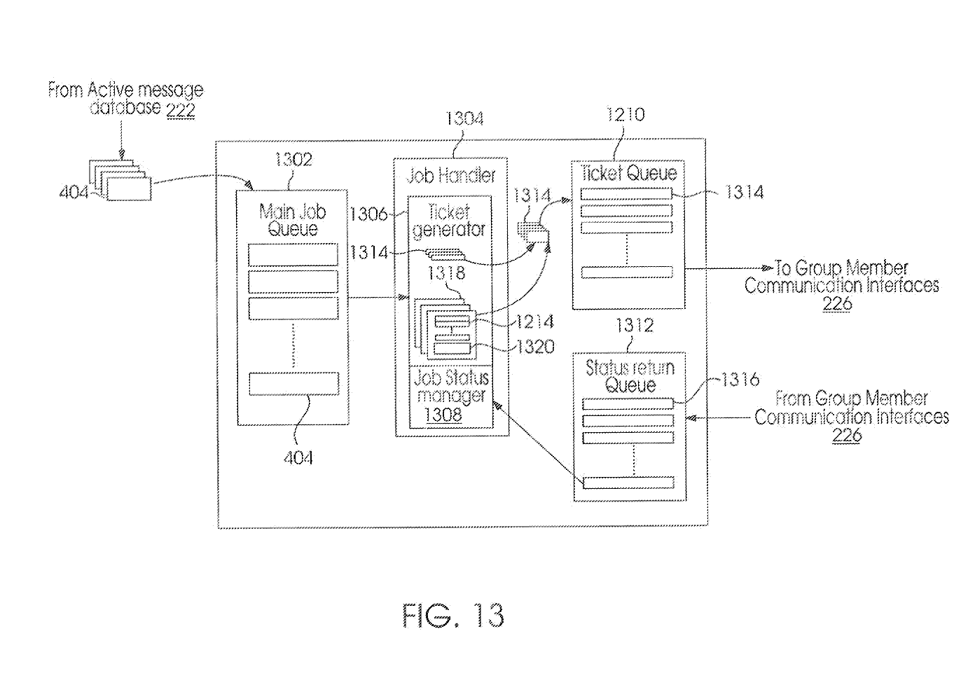

FIG. 13 illustrates one exemplary embodiment of an outbound routing controller 502 for efficiently performing steps 906-920 discussed above. In this embodiment, the outbound routing controller 502 includes a main job queue 1302, a job handler 1304 (which is comprised of a ticket generator 1306 and a job status manager 1308), a ticket queue 1310, and a status return queue 1312.

In operation, the main job queue 1302 receives a plurality of message job files 404 from the active message database 222. As noted above, each message job file 404 includes a prime user created message 406 along with the necessary information 408 (which may include message priority levels, group member transmission preferences, and preferences for including advertising and/or sponsorship information) to complete the message transmission. The message job files 404 are then sorted and placed within the main job queue 1302 first based on their priority level and then based on a first-in-first-out (FIFO) basis. Of course, it is understood that any other method may also be used for sorting the messages.

The queued message job files 404 are then retrieved and opened by the job handler 1304, where the ticket generator 1306 prepares a group of tickets 1314 for each job. Each ticket 1314 preferably corresponds to a single messaging action for a single group member contact preference, such as a voice dial, a text message transmission, an email transmission, an IM transmission, a web page posting, etc. The generated tickets 1314 are then passed to the ticket queue 1310, where the tickets 1314 are again sorted first based on a priority level and then on a FIFO basis. These tickets 1314 are then passed to the various group member communication interfaces 226, which utilize the information provided in the tickets 1314 to perform the appropriate messaging action.

Of course, as with the main job queue 1302, it should be understood that while one method for sorting tickets in the ticket queue 1314 has been described, any method may be used for sorting the messages. It should also be understood that although a single ticket queue is illustrated for the sake of clarity, the outbound routing controller 502 may include a separate ticket queue for each communication sever.

The status return queue 1312 collects information regarding the result of each messaging action that was taken by the group member communication servers. Thus, as discussed above, for each message transmitted to a group member's contact preference, the status return queue 1312 receives a status message 1316 from the group member interfaces indicating whether the message was received by the group member's communication device, whether the message was confirmed by the group member, and/or whether feedback was provided by the group member. This information regarding the status of each message action may also be passed to the status collection manager 506 to allow such information to be stored in the status database and made accessible to a prime user or other authorized individual.

The received status messages 1316 are preferably placed in the status return queue 1312 on a FIFO basis and then passed to the job stains manager. Based on the received status messages 1316, the job status manager 1308 then determines whether previously submitted tickets 1314 should be closed as completed or resubmitted to the ticket queue 1310.

In the case where a group member's information identifies multiple contact preferences, the ticket generator 1306 may also be configured to prepare a ticketbook 1318. In the exemplary embodiment shown in FIG. 13, each ticketbook 1318 contains multiple individual tickets 1314, each of which corresponds to a single messaging action for one of the group member's identified contact preferences. Each ticketbook 1318 may also include the governing logic 1320 to determine when and if each ticket within the ticketbook should be passed to the ticket queue, which may be based on certain group member preference that had been previously set.

For example, a group member's contact preferences may indicate that they prefer to receive messages using voice on a landline phone. Their secondary contact preference may then be identified as a text on a cellular phone, and their third contact preference may be by email. In this case, the ticket generator 1306 may prepare a ticketbook 1318 including one ticket corresponding to the voice transmission to the landline phone, one ticket corresponding to a text transmission to the cellular phone, and one ticket corresponding to the email transmission. The ticketbook 1318 would also include governing logic indicating the order in which the tickets should be placed (i.e. voice, then text, then email), and the conditions (i.e. whether the message was received or, if applicable whether confirmation or feedback was received) to determine when and whether to send each ticket to the ticket queue. The job status manager 1308, upon receiving a status message, would then refer to the governing logic within the ticketbook to determine whether to close the ticketbook, resubmit the previously submitted ticket, or submit a new ticket from the ticketbook.

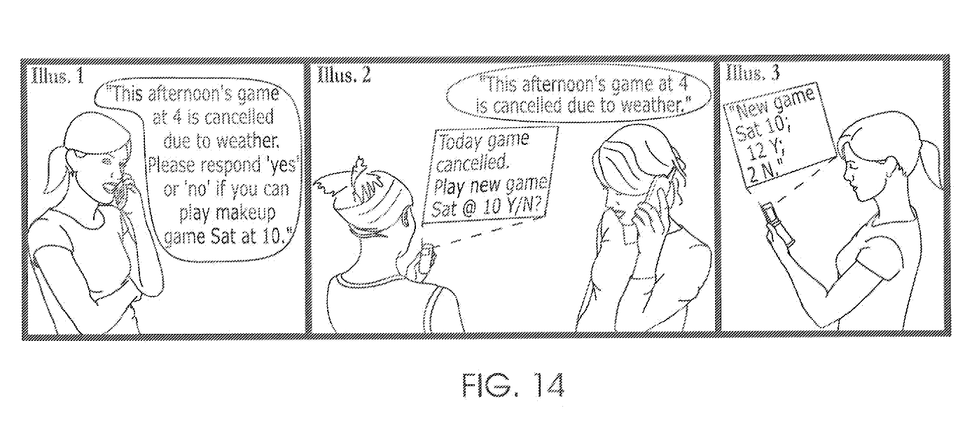

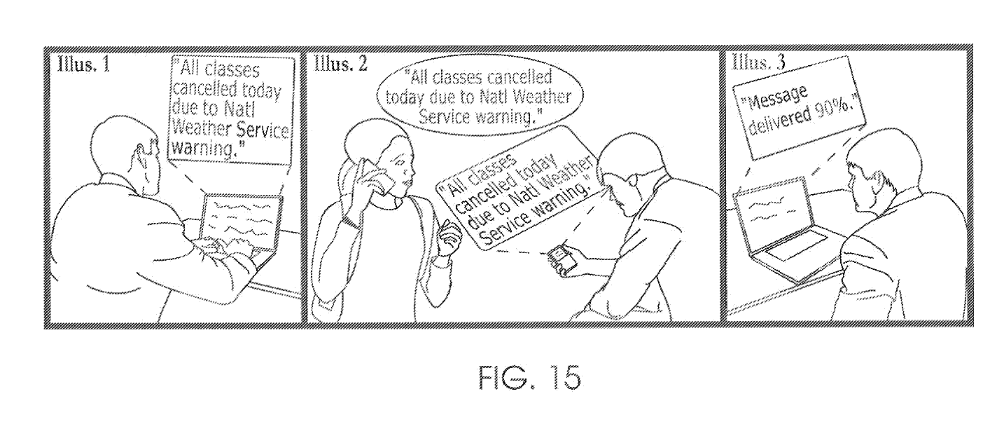

By means of the above described invention, a system and method is provided to conduct rapid two-way communications between a group of users across multiple platforms. This enables members of a group to efficiently communicate with one another regardless of the communication device being used by each group member or the location of each group member. For instance, in the case of a sports team, the present invention allows coaches to quickly, and using any form of communication, inform players, other coaches, referees, and even parents of any logistical changes such as a game cancellation or the change in a game location (see, for example, the illustration of FIG. 14). It also permits the coach to easily obtain feedback regarding whether the various group members would be available for a game at a different time or location. In the case of a school, the present invention may also be used to quickly and efficiently notify students, parents, and/or teachers of class cancellation (see, for example, the illustration of FIG. 15). Of course, these are but a couple of illustrations of uses for the present invention, and one skilled in the art would readily understand that the present invention may be applied to a number of different fields, including corporations, government agencies and municipalities, theatre, performing, and church groups, trade associations, advocacy groups, professional organizations, clubs, tour groups, polling organizations, parent-teacher school organizations, etc.

Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from foe scope or spirit of the present disclosure, and it is intended that the present disclosure covers all such modifications and variations provided they come within the scope of the following claims and their equivalents.

What is claimed is:

1. A communications system for enabling communications between a prime user and members of a group comprising:
a first set of interfaces capable of communicating with the prime user via a first plurality of communication platforms using at least a first format and a second format;
a second set of interfaces capable of communicating with each of the members of the group via a second plurality of communication platforms using at least the first format and the second format;
a session manager coupled to the first set of interfaces and having a plurality of routines configured to enable a prime user in communication with any one of the first set of interfaces to create a message to be transmitted to a selected group, the session manager capable of receiving the message from the prime user in either the first format or the second format;
a first format converter capable of converting the message from the first format to the second format;
a first database coupled to the session manager and the format converter capable of storing the message created by the prime user in both the first format and the second format;
a second database coupled to the session manager to store information about the members of the group, the group member information including contact information identifying one or more contact addresses for each of the group members and format information identifying a format in which each group member would prefer to receive messages;
a communication controller configured to obtain the message from the first database in both the first and second formats, to obtain the group member information from the second database, and to initiate transmission of the message from the second set of interfaces to the selected group members using at least one of the second set of communication platforms based on the contact information and the format information for each selected group member;
wherein the message is transmitted to some of the selected group members in a first format, and the message is transmitted to others of the selected group members in a second format.

2. The system of claim 1 wherein the message is transmitted to some of the selected group members using a first type of communication platform and the message is transmitted to others of the selected group members via a second type of communication platform; wherein the first type of communication platform is selected from one of a phone call, text message, email, instant message, or web browser.

3. The system of claim 1 wherein the first format is one of the group consisting of voice, text and video, and the second format is a different one of the group consisting of voice, text, and video.

4. The system of claim 3 wherein each of the first and second set of interfaces includes at least one of a phone interface, a SMS message server, an email server, an instant messaging server, and a web server.

5. The system of claim 1 wherein communication controller further includes an advertising manager for inserting at least one of an advertisement or sponsorship information into the message being transmitted to the selected group members.

6. The system of claim 1 wherein the communication controller is further configured to determine status information for each selected group member to whom the message was transmitted, the status information including information regarding at least one of whether the message was received by a particular group member, whether the message was confirmed by the particular group member, and whether feedback was received from the particular group member.

7. The system of claim 6 wherein the communication controller is further configured to determine whether to resend the message to each selected group member based on the status information for the respective group member.

8. The system of claim 1 wherein the communication controller is configured to receive responses to the transmitted message from the selected group members via the second set of interfaces;
wherein responses from one portion of the selected group members are received in the first format and responses from another portion of the selected group members are received in a second format; and
wherein the system further includes a second format converter capable of converting responses received in the first format to the second format and to convert responses received in the second format to the first format.

9. The system of claim 8 wherein the session manager further includes a plurality of routines configured to enable a prime user in communication with any one of the first set of interfaces to review the feedback in either the first format or in the second format.

10. The system of claim 8 wherein information regarding the received responses is transmitted to the prime user via one of the first set of interfaces.

11. The system of claim 1 wherein the session manager further includes a plurality of routines configured to enable a prime user in communication with any one of the first set of interfaces to input at least a portion of the group information.

12. A method for enabling communications between a prime user and members of a group comprising:
providing a second set of interfaces capable of communicating with the prime user via a second plurality of communication platforms using at least a first format and a second format;
providing a second set of interfaces capable of communicating with the members of the group via a second plurality of communication platforms using at least a first format and a second format;
obtaining information regarding the members of the group, the group member information including contact information identifying one or more contact addresses for each of the plurality of group members, and format information identifying a format in which each group member would prefer to receive messages;
receiving a message from a prime user in the first format via one of the first plurality of communication platforms;
converting the message from the first format to the second format; and
transmitting the message to selected ones of the group members using at least one of the second plurality of communication platforms based on the contact information and the format information provided for each group member;
wherein the message is transmitted to a portion of the selected group members using the first format and the message is transmitted to another portion of the selected group members using the second format.

13. The method of claim 12 further including receiving status information for each selected group members, the status information including information regarding at least one of (1) whether the message was received, (2) whether the message was confirmed, and (3) whether feedback to the message was provided.

14. The method of claim 13 further including determining whether to resend the message to a first one of the selected group members based on the status information for that group member.

15. The method of claim 14 further including resending the message to the first one of the selected group members based on the group member information for the first one of the selected group members.

16. The method of claim 12 further including forwarding a message sent to one of the members of the group to a secondary individual that is not a member of the group.

17. The method of claim 12 wherein the group information further includes a priority level for messages transmitted to members of the group, wherein the priority level is chosen from at least one of (a) a first priority level in which the message is transmitted at a specified day and time to a primary contact address for each member of the group, (b) a second priority level in which the message is sent at the end of the day the primary contact address for each member of the group, (c) a third priority level in which the message is sent immediately upon creation of the message to the primary contact address for each member of the group, and (d) a fourth priority level in which the message is sent as an urgent message to each contact address for each member of the group.
